(19) United States
(12) Patent Application Publication
(10) Pub. No.: US 2008/0136768 A1
(43) Pub. Date: Jun. 12, 2008

(54) DISPLAY APPARATUS AND METHOD FOR CONTROLLING CONTRAST THEREOF

(75) Inventor: Shu-Wen Chuang, Taipei City (TW)

Correspondence Address: J C PATENTS, INC., 4 VENTURE, SUITE 250, IRVINE, CA, 92618, US

(73) Assignee: INVENTEC CORPORATION, Taipei City (TW)

(21) Appl. No.: 11/671,842

(22) Filed: Feb. 6, 2007

(30) Foreign Application Priority Data
Dec. 11, 2006 (TW) 95146212

(51) Int. Cl. G09G 3/36

(52) U.S. Cl. 345/102

(57) ABSTRACT

A method of controlling the contrast of a display apparatus including the following steps is provided in the present invention. First, the brightness distribution ratios of an image signal are compiled and the backlight brightness of the display apparatus is adjusted according to the brightness distribution ratios of the image signal. The contrast of the display apparatus is thereby adjusted in the method disclosed in the invention.

### CROSS-REFERENCE TO RELATED APPLICATION

This application claims the priority benefit of Taiwan application serial no. 95146212, filed Dec. 11, 2006. All disclosure of the Taiwan application is incorporated herein by reference.

### BACKGROUND OF THE INVENTION

1. Field of the Invention

The present invention relates to a display apparatus, especially to a display apparatus that can automatically adjust the frame contrast thereof.

2. Description of Related Art

Nowadays, it is the era of 3C, namely computer, communication and consumer electronics. In such a life-style, many information devices of various kinds are available on the market, like mobile phone, personal digital assistant (PDA), Global Positioning System (GPS), digital camera and display apparatus. Most information devices use the flat panel display apparatus as the main communication interface.

In the past, almost all the display apparatus uses the cathode-ray tube (CRT). Owing to development on the technology of fabricating the semiconductor in recent years, the liquid crystal display (LCD) apparatus or the plasma display apparatus now have the advantages of light weight, thin thickness, short length, small size and low power consumption over the conventional cathode-ray tube.

The display apparatuses include specifications such as view angle, weight, power consumption, response speed, resolution and contrast. Contrast refers to the measurement of different levels of brightness between the brightest white and the darkest black in an image. When the difference in brightness levels gets bigger, it means greater contrast. Conversely, when the difference in brightness levels gets smaller, it means less contrast. Good contrast rate can easily display vivid and lush colors and it also supports colors of different color levels.

However, in the prior art, it is rather difficult to raise the contrast independently.

### SUMMARY OF THE INVENTION

A display apparatus, which can automatically adjust the contrast thereof, is provided in the present invention.

The invention provides a method of controlling the contrast of a display apparatus that independently raises the contrast.

In order to solve the foregoing problems, the invention provides a display apparatus including a display panel, a backlight module and a control module. The backlight module is used for providing the display light source of the display panel. The control module is coupled to the display panel and the backlight module so as to receive an image signal and compile brightness distribution ratios. The control module then controls the backlight module to adjust the brightness of the display frame according to the brightness distribution ratio of the image signal.

According to one embodiment of the present invention, the grey level range of the image signal of the said display apparatus includes a first sub-range, a second sub-range and a third sub-range. The brightness distribution ratios within the first, the second and third sub-ranges of the image signal are a first ratio, a second ratio and a third ratio.

According to one embodiment of the invention, the control module of the said display apparatus compares the first, the second and the third ratios. If the second ratio is bigger than the first ratio and the third ratio, the control module controls the backlight module so as to provide a normal brightness. If the first ratio is bigger than the second ratio and the third ratio, the control module controls the backlight module so as to provide a reduced brightness. If the third ratio is bigger than the first ratio and the second ratio, the control module controls the backlight module so as to provide an increased brightness.

From another aspect, the invention provides a method of controlling the contrast of a display apparatus including compiling the brightness distribution ratios of an image signal and adjusting the backlight brightness of the display apparatus according to the brightness distribution ratios of the image signal.

According to one embodiment of the invention, in the said method of controlling the contrast of the display apparatus, the grey level range of the image signal includes a first sub-range, a second sub-range and a third sub-range. The brightness distribution ratios within the first, the second and the third sub-ranges of the image signal are a first ratio, a second ratio and a third ratio respectively.

According to one embodiment of the invention, the method of controlling the contrast of the display apparatus further includes comparing the first, the second and the third ratios. If the second ratio is bigger than the first ratio and the third ratio, the backlight brightness of the display apparatus is adjusted to a normal brightness. If the first ratio is bigger than the second ratio and the third ratio, the backlight brightness of the display apparatus is adjusted to a reduced brightness. If the third ratio is bigger than the first ratio and the second ratio, the backlight brightness of the display apparatus is adjusted to an increased brightness.

When the display apparatus of the invention receives an image signal, it compiles the brightness distribution ratios thereof. Next, according to the brightness distribution ratios of the image signal, the backlight brightness of the display apparatus is adjusted through the backlight module. Therefore, the contrast is independently adjusted through the invention.

In order to make the aforementioned and other objects, features and advantages of the present invention more comprehensible, preferred embodiments accompanied with figures are described in detail below.

### BRIEF DESCRIPTION OF THE DRAWINGS

FIG. 1 is a circuit diagram of a display apparatus according to one preferred embodiment of the present invention.

FIG. 2 is a brightness distribution diagram of the invention.

FIG. 3 is another brightness distribution diagram of the invention.

FIG. 4 is a flowchart showing the steps of a method controlling the contrast of a display apparatus according to one preferred embodiment of the invention.

### DESCRIPTION OF EMBODIMENTS

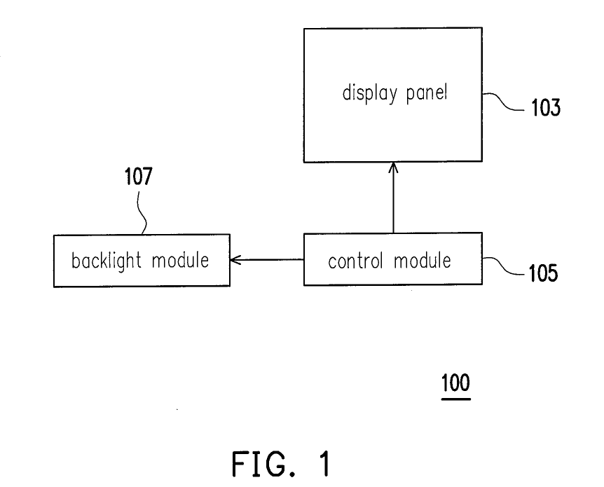

FIG. 1 is a circuit diagram of a display apparatus 100 according to one preferred embodiment of the present invention. Referring to FIG. 1, a display apparatus of the present embodiment includes a display panel 103, a backlight module 107 and a control module 105. The backlight module 107 is used to provide the necessary display light source for the display panel 103. The control module 105 produces and transmits a control signal to the backlight module and adjusts the brightness of the display frame through the backlight module 107. In addition, the control module 105 also transmits the image signal to the display panel 103 so as to produce a display frame.

In the present embodiment, the display panel may be a liquid crystal display (LCD) panel. It is well known that besides scan lines a display panel also includes data lines perpendicular to the scan lines and pixel units disposed where each of the scan lines and each of the data lines intersect. In order to avoid obscuring the spirit of the invention, the said elements are not disclosed in the present embodiment. However, people who are ordinarily skilled in the art should know the display panel includes other elements. Hence, the said elements are not to be reiterated herein. Moreover, the backlight module of the embodiment may be implemented by a cold cathode lamp and the corresponding driving circuit or a light emitting diode (LED) and the corresponding circuit.

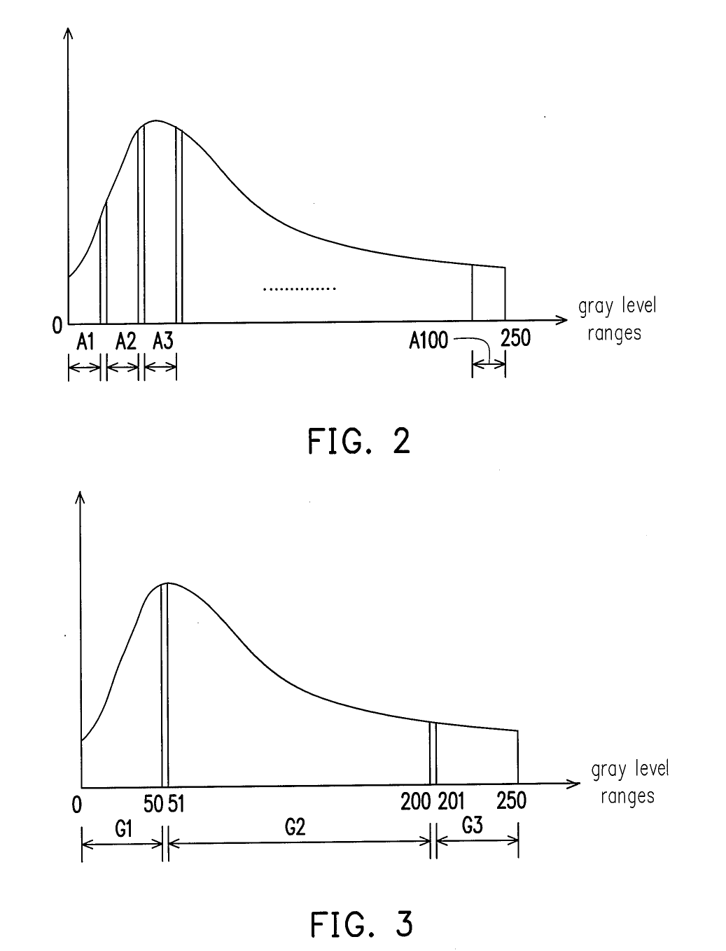

FIG. 2 is a brightness distribution diagram of the invention. Referring to FIG. 2, in the embodiment, when the display apparatus 100 receives the image signal, it creates a brightness distribution diagram showing the statistics of the image data through a program, a circuit or otherwise. In the embodiment, the grey level range is from the zero level to the 250^{th} level with every 25 levels as one unit. Therefore, the diagram is divided into 100 sub-ranges in all, A1-A100. Afterwards, the ratios of the brightness distribution in each of the sub-ranges, each of the frames in the image signal and the number of the pixels within an sub-range to the total number of pixels are compiled respectively. For example, when the number of total pixels in a frame of the image signal is 600×800=480000, and the number of the pixels with brightness within the zero level to the 25^{th} level of the frame is 500, the brightness distribution ratio thereof is around 0.1%. It is noted that in the present embodiment, the grey level range of the brightness distribution diagram of any image signal is from the zero level to the 250^{th} level.

However, people who are skilled in the art should know the grey level range of the embodiment is not limited to the range between the zero level and the 250^{th} level. They can set the grey level range within the grey levels to suit their needs. In addition, the brightness distribution diagram of the embodiment does not require that every 50 gray levels be one unit and the diagram be divided into 100 sub-ranges. Those skilled in the art may increase or decrease the number of sub-ranges in the brightness distribution diagram.

FIG. 3 is another brightness distribution diagram of the invention. Referring to FIG. 3, in the present embodiment, the grey level range is divided into a first sub-range G1, a second sub-range G2 and a third sub-range G3 for the convenience of explanation. The grey level range of the first sub-range G1 is from the 0^{th} level to the 50^{th} level. The grey level range of the second sub-range G2 includes from the 51^{st} level to the 200^{th} level. The grey level range of the third sub-range G3 includes from the 201^{st} level to the 250^{th} level.

Referring to both FIGS. 1 and 3, if the brightness distribution ratio of the first sub-range G1 is 60%, the brightness distribution ratio of the second sub-range G2 is 30% and the brightness distribution ratio of the third sub-range G3 is 10%, it means the frame of the image signal is on the dark side. Therefore, the control module 105 produces and transmits a control signal to the backlight module 107 such that the backlight module 107 provides the reduced brightness to the display panel and the contrast of the display frame is thus raised.

If the brightness distribution ratio of the first sub-range G1 is 10%, the brightness distribution ratio of the second sub-range G2 is 30% and the brightness distribution ratio of the third sub-range G3 is 60%, it means the frame of the image signal is on the bright side. Therefore, the control module 105 produces and transmits a control signal to the backlight module 107 such that the backlight module 107 provides the increased brightness to the display panel and the contrast of the display frame is thus raised.

If the brightness distribution ratio of the first sub-range G1 is 20%, the brightness distribution ratio of the second sub-range G2 is 60% and the brightness distribution ratio of the third sub-range G3 is 20%, it means the frame of the image signal is neither too bright nor too dark.

Hence, the control module 105 controls the backlight module so that the backlight module provides the normal brightness to the display panel.

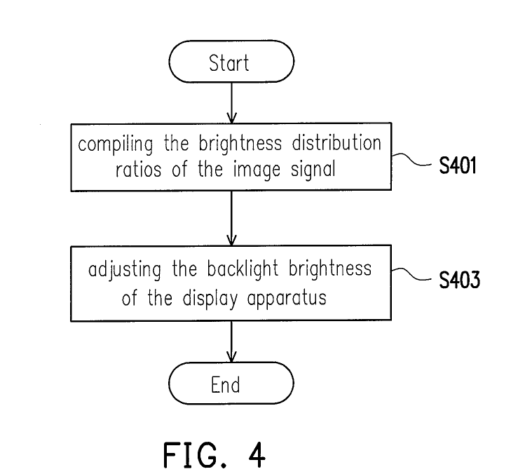

FIG. 4 is a flowchart showing the steps of a method of controlling the contrast of a display apparatus according to one preferred embodiment of the invention. Referring to FIG. 4, the method of controlling the contrast of the display apparatus in the present embodiment includes the following steps. When the display apparatus receives an image signal, first the brightness distribution ratios of the image signal are compiled (step S401). The grey level range of the image signal includes a first sub-range, a second sub-range and a third sub-range. In the present embodiment, the grey level range of the first sub-range is from the zero level to the 50^{th} level; the second sub-range is from the 51^{st} level to the 200^{th} level and the third sub-range is from the 201^{st} level to the 250^{th} level.

Furthermore, in the said grey level ranges, the brightness distribution ratio of the first sub-range is the first ratio; the brightness distribution of the second sub-range is the second ratio and the brightness distribution ratio of the third sub-range is the third ratio. Afterwards, the backlight brightness of the display apparatus is adjusted according to the brightness distribution ratio of each of the sub-ranges (step S403).

When the first ratio is bigger than the second ratio and the third ratio, it means the frame of the image signal is on the dark side. Thus, the backlight brightness of the display apparatus is adjusted as the reduced brightness and lowering the brightness of the backlight thus achieves the effect of raising the contrast of the display frame.

When the third ratio is bigger than the first ratio and the second ratio, it means the frame of the image signal is on the bright side. Hence, the backlight of the display apparatus is adjusted as the increased brightness and raising the brightness of the backlight thus achieves the effect of raising the contrast of the display frame.

When the second ratio is bigger than the first ratio and the third ratio, it means the frame of the image signal is neither too bright nor too dark. Therefore, the normal brightness is provided for the display panel.

In summary, when the display apparatus of the invention receives an image signal, it compiles the brightness distribution ratios thereof. Next, according to the brightness distribution ratios of the image signal, the backlight brightness of the display apparatus is adjusted through the backlight module. Accordingly, the contrast is independently adjusted through the present invention.

Although the present invention has been disclosed above by the embodiments, they are not intended to limit the present invention. Anybody skilled in the art can make some modifications and alteration without departing from the spirit and scope of the present invention. Therefore, the protecting range of the present invention falls in the appended claims.

What is claimed is:

1. A display apparatus, comprising:
a display panel;
a backlight module, used for providing a display light source of the display panel; and
a control module, coupled to the display panel and the backlight module thereof and used for receiving an image signal, compiling the brightness distribution ratios thereof and adjusting the brightness of the display frame by controlling the backlight module according to the brightness distribution ratios of the image signal.

2. The display apparatus of claim 1, wherein the grey level range of the image signal comprises includes a first sub-range, a second sub-range and a third sub-range, the brightness distribution ratios of the first, the second and the third sub-ranges of the image signal being a first ratio, a second ratio and a third ratio.

3. The display apparatus of claim 2, wherein the first sub-range is the zero level to the 50^{th} level, the second sub-range being the 51^{st} level to the 200^{th} level, the third sub-range being the 201^{st} level to the 255^{th} level.

4. The display apparatus of claim 2, wherein the control module compares the first, the second and the third ratios;
if the second ratio bigger than the first ratio and the third ratio, the control module controlling the backlight module so as to provide a normal brightness;
if the first ratio bigger than the second ratio and the third ratio, the control module controlling the backlight module so as to provide a reduced brightness; and
if the third ratio bigger than the first ratio and the second ratio, the control module controlling the backlight module so as to provide an increased brightness;

5. The display apparatus of claim 1, wherein the display panel is a liquid crystal display (LCD) panel.

6. The display apparatus of claim 1, wherein the backlight module comprises a cold cathode lamp and the corresponding driving circuit.

7. The display apparatus of claim 1, wherein the backlight module comprises a light emitting diode (LED) and the corresponding driving circuit.

8. A method of controlling the contrast of a display apparatus, comprising:
compiling the brightness distribution ratios of an image signal; and
adjusting the backlight brightness of the display apparatus according to the brightness distribution ratios of the image signal.

9. The method of controlling the contrast of the display apparatus of claim 8, wherein the grey level range of the image signal comprises a first sub-range, a second sub-range and a third sub-range, the brightness distribution ratios within the first, the second and the third sub-ranges of the image signal being respectively a first ratio, a second ratio and a third ratio.

10. The method of controlling the contrast of the display apparatus of claim 9, wherein the first sub-range is the zero level to the 50^{th} level, the second sub-range being the 51^{st} level to the 200^{th} level, the third sub-range being the 201^{st} level to the 255^{th} level.

11. The display apparatus of claim 9, wherein the steps of adjusting the backlight brightness of the display apparatus comprise:
comparing the first, the second and the third ratios.
if the second ratio bigger than the first ratio and the third ratio, adjusting the backlight brightness of the display apparatus to a normal brightness;
if the first ratio bigger than the second ratio and the third ratio, adjusting the backlight brightness of the display apparatus to a reduced brightness; and
if the third ratio bigger than the first ratio and the second ratio, adjusting the backlight brightness of the display apparatus to an increased brightness.
